(19) United States
(12) Patent Application Publication
(10) Pub. No.: US 2026/0238939 A1
(43) Pub. Date: Aug. 13, 2026

(54) In-The-Ear Hearing Device Having a Removable Seal Module

(71) Applicant: SONOVA AG, Staefa (CH)

(72) Inventors: Danny Cheng, Fremont, CA (US); Shashank Nagash, Fremont, CA (US); Xiuming Zhu, San Jose, CA (US); Grace Gardner, Bend, OR (US); Michael Au, Union City, CA (US); Daniel Probst, Uerikon (CH)

(21) Appl. No.: 19/053,188

(22) Filed: Feb. 13, 2025

(51) Int. Cl. H04R 25/00

(52) U.S. Cl. CPC H04R 25/656; H04R 25/602; H04R 25/604; H04R 25/609

(57) ABSTRACT

An illustrative in-the-ear hearing device seal module for use with a hearing device core includes a sleeve-shaped seal carrier that defines a longitudinal axis and that is configured to be inserted into an ear canal. The seal carrier further includes a sound outlet at a medial end of the seal carrier when the seal carrier is inserted into the ear canal. At least one seal element is provided on a shell surface of the seal carrier. The hearing device core is at least partially inserted into and positioned by the seal carrier such that the seal carrier is secured to the hearing device core by a releasable form-fit coupling.

### FIELD OF THE INVENTION

The present inventions relate generally to hearing devices and, for example, hearing devices that are worn at least partially in the ear canal.

### BACKGROUND INFORMATION

As shown in FIG. 1, an adult ear canal 10 extends from a canal aperture 12 to the tympanic membrane/eardrum and includes a lateral cartilaginous region 16 and a bony region 18 which are separated by the bony-cartilaginous junction 20. Debris 22 and hair 24 in the ear canal are primarily present in the cartilaginous region 16. The concha cavity 26 and auricle 28 are located lateral of the ear canal 10, and the junction between the concha cavity 26 and cartilaginous region 16 of the ear canal at the aperture 12 is also defined by a characteristic bend 30, which is known as the first bend of the ear canal.

Extended wear hearing devices are configured to be worn continuously, from several weeks to several months, inside the ear canal. Some extended wear hearing devices are configured to rest entirely within the bony region and, in some instances, within 4 millimeters (mm) of the tympanic membrane. Examples of extended wear hearing devices are disclosed in U.S. Pat. No. 9,071,914, U.S. Pat. No. 7,664,282 and U.S. Pat. No. 8,682,016.

Another example disclosing a so-called completely in-the-canal (“CIC”) hearing device is disclosed in U.S. Pat. No. 10,701,497. Said reference uses the term hearing device seal module for the entire CIC. The hearing device seal module comprises a device core in which all the electronics and a power source are provided that are required to mitigate a hearing impairment of an end user wearing such a hearing device seal module. The hearing device has a tubular seal carrier formed of a resilient material. The seal carrier has a sound outlet at its medial end when inserted into the ear canal and that is attached to the device core. A seal element made of a foam material is permanently (e.g., for lifetime, no undesired loss within ear canal) attached to the shell surface of the seal carrier. Since not all customers have the very same ear anatomy with an ear canal having a cylindric cross-section of the same diameter, a hearing device supplier must offer the same device in different sizes and shapes to cover the needs of most potential end customers.

It is important that the seal element or the seal elements are properly sized for the intended ear canal. An extended wear hearing device with improperly sized seals may result in a less-than-optimal insertion depth within the ear canal and/or gaps and folds in the seal. A suboptimal insertion depth and/or a poor seal/ear canal interface may result in discomfort, injury to the ear canal, and inadequate acoustic feedback suppression, for example. Given the fact that hearing devices are placed in ear canals of varying shapes and sizes, hearing device manufactures typically manufacture hearing devices with a variety of seal sizes. For example, a particular hearing device may be manufactured with any of seven different seal sizes (i.e., XXS, XS, S, M, L, XL and XXL), or combinations of sizes. The hearing device seal size is typically determined during the fitting process and the patient is provided with a pre-sized hearing device with appropriately sized seals.

Because such hearing device seal modules have a battery that is already built-in and enclosed in the device core, the limited shelf life of the hearing device seal modules result in a substantial amount of inventory waste and economic disadvantages. For example, once the shelf life has expired, the unused hearing device seal modules have to be disposed. Moreover, waste is created during the fitting period. To illustrate, the end user receives a hearing device seal module, but the subsequent test period proves that there is a poor fit of the hearing device seal module in the ear canal such that there is a leakage in a direct sound path that affects the hearing performance negatively. Due to the poor fit of the hearing device seal module, the hearing device seal module may be disposed after the test period.

Accordingly, there is a desire to find a solution to address the need to adapt in-the-ear hearing devices (e.g., CICs and/or in-the-ear devices (“ITEs”)) when customizing them to the end user's individual needs. It may further be desirable for components of the in-the-ear hearing devices to be kept in stock at the health care practitioner (“HCP”) that is fitting the hearing devices to the end users so as to include end users having an ear anatomy that is less common than other ear anatomies in receiving a satisfactory hearing aid solution.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative implementation of anatomical features of an ear and ear canal.

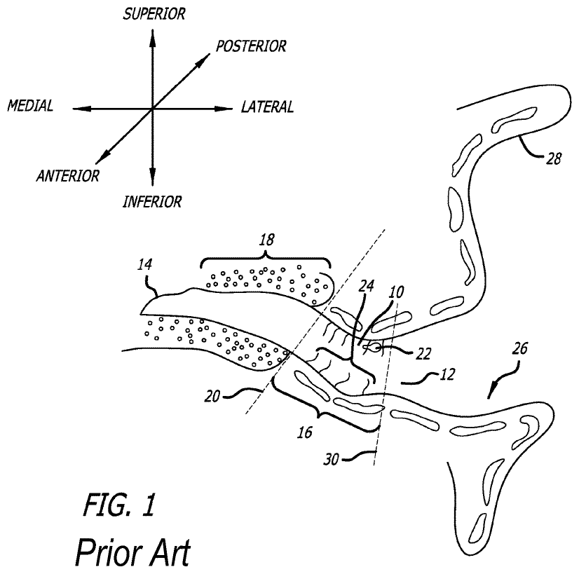

FIGS. 2A and 2B show an illustrative implementation of a hearing device system including a hearing device core releasably coupled with a hearing device seal module.

FIGS. 3A-3C show an illustrative implementation of a hearing device core.

FIGS. 4A and 4B show an illustrative implementation of a hearing device seal module.

FIGS. 5A and 5B show an illustrative implementation of a hearing device core being inserted within a hearing device seal module.

FIGS. 6A-6C another illustrative implementation of a hearing device core being inserted within a hearing device seal module.

FIGS. 7A and 7B show an illustrative implementation of a hearing device core inserted within a hearing device seal module.

FIGS. 8A and 8B show an illustrative implementation of a releasable coupling for use with a hearing device seal module.

FIG. 9 shows an illustrative implementation of a hearing device core inserted within a hearing device seal module.

FIGS. 10A-10C show illustrative implementations of hearing device seal modules for use with a hearing device system.

FIG. 11 shows another illustrative implementation of a hearing device seal module for use with a hearing device system.

FIGS. 12A-12C show illustrative implementations of hearing device seal modules for use with a hearing device system.

FIGS. 13A-13C show illustrative implementations of hearing device seal modules for use with a hearing device system.

### DETAILED DESCRIPTION

An illustrative in-the-ear hearing device seal module for use with a hearing device core includes a sleeve-shaped seal carrier that defines a longitudinal axis and that is configured to be inserted into an ear canal. The seal carrier further includes a sound outlet at a medial end of the seal carrier when the seal carrier is inserted into the ear canal. At least one seal element is provided on a shell surface of the seal carrier. The hearing device core is at least partially inserted into and positioned by the seal carrier such that the seal carrier is secured to the hearing device core by a releasable form-fit coupling.

Some implementations also include hearing device systems with a hearing device core in combination with one or more such hearing device seal modules (e.g., having different seal configurations).

The principles described herein may result in improved hearing device systems compared to conventional systems that do not include a hearing device seal module releasably coupled to a hearing device core by a releasable form-fit coupling, as well as provide other benefits as described herein. For example, such a hearing device seal module may be coupled and/or decoupled with a hearing device core, which may allow the seals to be removed and replaced if necessary (e.g., based on patient feedback). A wide variety of seal sizes may be stored (as portions of seal modules) at a fitting facility, including rarely used sizes and differently sized seals, because the seals (and the present seal modules) are relatively inexpensive and are unlikely to expire prior to use. As such, the present hearing device seal modules and associated methods allow fitting facilities to store an appropriate number of hearing device cores, based on the expected number of patients and without regard to seal size, thereby reducing carrying costs and waste due to core expiration.

Moreover, the seal carrier of the present seal module is sufficiently rigid so as to retain a level of stiffness that does not easily collapse during handling. Such rigidity of the seal carrier allows the hearing device core to be inserted within the seal module without the need to prepare a tool having wire projections configured to hold a balloon open for insertion of the hearing device core. Accordingly, the hearing device seal module provides a more efficient and easily repeatable process for inserting the seal module and hearing device core into the patient ear (e.g., by requiring less tools and/or steps). The hearing device seal module further includes a cavity for receiving the hearing device core having a stop configured to prevent the hearing device core from protruding farther than designed through the seal module, which may allow for assembly of the seal module and hearing device core to be performed more accurately and easily by an HCP.

Various embodiments will now be described in more detail with reference to the figures. The systems, hearing devices, and methods described herein may provide one or more of the benefits mentioned above and/or various additional and/or alternative benefits that will be made apparent herein.

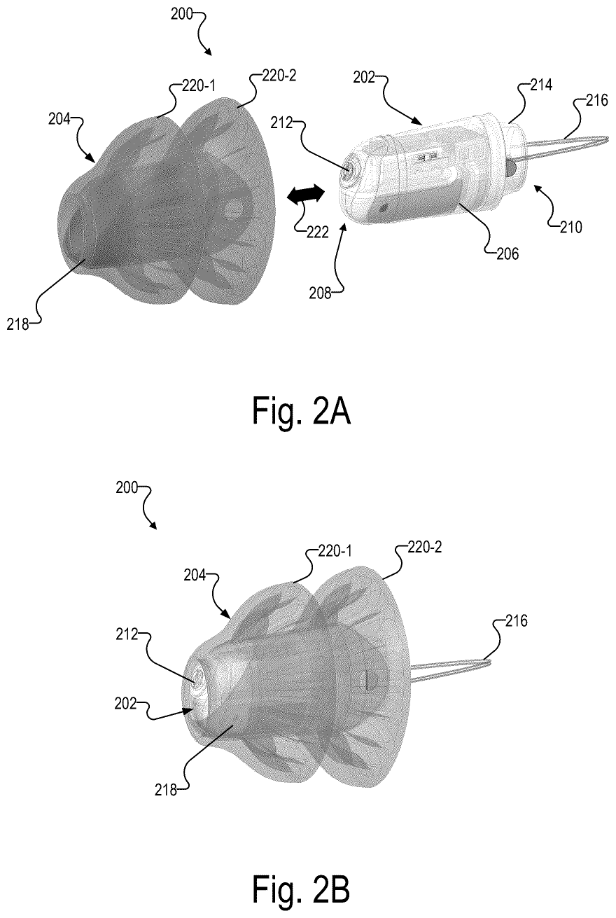

FIGS. 2A and 2B show an illustrative implementation 200 of a hearing device system including a hearing device core 202 and a hearing device seal module 204. For example, FIG. 2A shows a perspective view of hearing device core 202 decoupled from hearing device seal module 204 and FIG. 2B shows a perspective view of hearing device core 202 at least partially inserted within hearing device seal module 204. Hearing device system 200 may be configured as one of a CIC or an ITE.

Hearing device core 202 may be implemented by any type of hearing device core configured to enable or enhance hearing by a user wearing hearing device core 202. For example, hearing device core 202 may be configured to provide an amplified version of audio content to a user. As shown, hearing device core 202 includes a housing 206, with medial end 208 and a lateral end 210, a receiver port 212, a contamination guard 214, and a removal loop 216.

Hearing device seal module 204 includes a seal carrier 218 and one or more seal elements 220 (e.g., seal elements 220-1 to 220-2) provided on seal carrier 218. Hearing device core 202 is configured to be at least partially inserted within hearing device seal module 204 such that hearing device core 202 is releasably couplable with hearing device seal module 204, as indicated by arrow 222. For example, medial end 208 of hearing device core 202 may be inserted within seal carrier 218 such as to couple hearing device core 202 with hearing device seal module 204. Additionally, removal loop 216 at lateral end 210 of hearing device core 202 may be grasped and pulled laterally (e.g., away from hearing device seal module 204) such as to decouple hearing device core 202 with hearing device seal module 204.

In at least some instances, hearing device seal module 204 is semi-permanently secured to hearing device core 202 when hearing device core 202 is coupled with hearing device seal module 204. As used herein, “semi-permanently secured” means that hearing device seal module 204 remains secured to hearing device core 202 under expected use conditions and that hearing device core 202 can be removed from hearing device seal module 204 without damage to hearing device core 202 and/or hearing device seal module 204 if so desired. For example, should it be determined during fitting that the one or more seal elements 220 are not the most optimal size, hearing device seal module 204 may be removed from hearing device core 202 and replaced with another hearing device seal module 204 having differently sized seal elements 220.

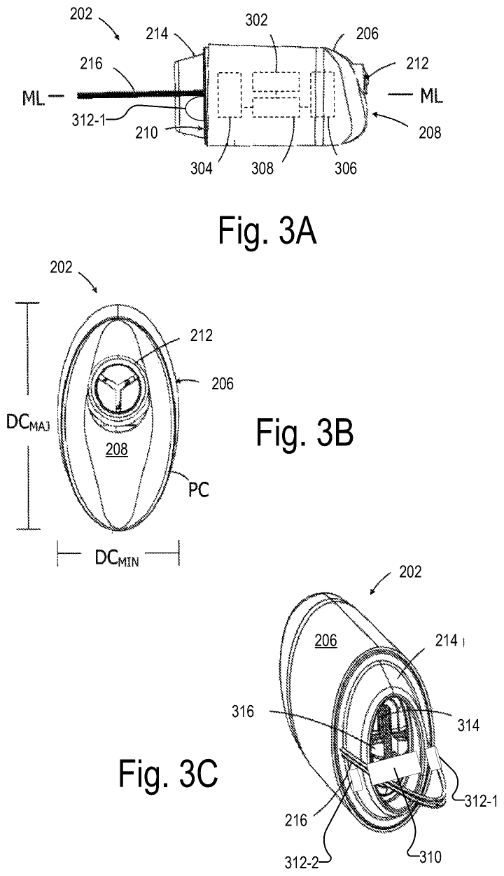

FIGS. 3A-3C show hearing device core 202 in more detail. For example, FIG. 3A shows a side view of hearing device core 202, FIG. 3B shows an end view of hearing device core 202, and FIG. 3C shows a perspective view of hearing device core 202.

As shown, hearing device core 202 has an oval shape (e.g., an elliptical or at least substantially elliptical shape), defined by an outer surface of the housing 206, in planes perpendicular to the medial-lateral axis ML that extends through the center of hearing device core 202. The oval shape defines a major dimension DC_{MAJ}, a minor dimension DC_{MIN}, and an outer perimeter PC. These dimensions taper (or decrease) slightly in the lateral to medial direction in the illustrative implementation. Additionally, receiver port 212 is not centered on the medial-lateral axis ML (e.g., housing 206 and receiver port 212 are not coaxial). While the illustrative hearing device core 202 is shown as having an oval shape, hearing device core 202 is not limited to any particular shape.

Hearing device core 202 further includes a battery 302, a microphone 304, a receiver 306, and control circuitry 308 that are operably connected to one another and are located within the housing 206. Hearing device core 202 may include additional or alternative components as may serve a particular implementation.

Battery 302 may be implemented by one or more suitable power sources configured to supply power to one or more components of hearing device core 202, such as microphone 304, receiver 306, and/or control circuitry 308. Battery 302 may be included in or communicatively coupled to hearing device core 202 in any suitable manner.

Microphone 304 may be implemented by one or more suitable audio detection devices configured to detect audio data representative of one or more audio signals presented to a user of hearing device core 202. The one or more audio signals may include, for example, audio content (e.g., music, speech, noise, etc.) generated by one or more audio sources included in an environment of the user. Microphone 304 may be included in or communicatively coupled to hearing device core 202 in any suitable manner.

Receiver 306 may be implemented by any suitable audio output device, for instance a loudspeaker, also called an “output transducer”, of a hearing device. Audio output by receiver 306 may be emitted from hearing device core 202 through receiver port 212.

Control circuitry 308 may be communicatively coupled with and configured to control operations of microphone 304 and/or receiver 306. For example, control circuitry 308 may be configured to control operation of various hardware components included in microphone 304 and/or receiver 306 such as to control detection and/or output of audio signals. Control circuitry 308 may include any suitable hardware (e.g., a processor, circuitry, etc.) and/or software as may serve a particular implementation. While FIG. 3A shows that control circuitry 308 is included in hearing device core 202, control circuitry 308 may alternatively be implemented in whole or in part separately from hearing device core 202, such as by a computing device communicatively coupled to hearing device core 202.

In some instances, hearing device core 202 may include an additional one or more sensors such as for determining one or more additional conditions of the user. To illustrate, hearing device core 202 may include a motion sensor and/or a physiological sensor, e.g., a heart rate sensor and/or a blood pressure sensor.

Hearing device core 202 of the illustrated implementation further includes a coupling rod 310 including one or more protrusions 312 (e.g., first protrusion 312-1 and second protrusion 312-2) configured to releasably engage hearing device seal module 204. For example, each end of coupling rod 310 includes a protrusion 312 that protrudes outwardly at lateral end 210 of hearing device core 202 (e.g., from housing 206 and/or contamination guard 214) to releasably engage seal carrier 218 of hearing device seal module 204. While the illustrated implementation shows coupling rod 310 extending through hearing device core 202 such that protrusions 312 of coupling rod 310 protrude from hearing device core 202, protrusions 312 may alternatively be provided on hearing device core 202 (e.g., housing 206 and/or contamination guard 214) without coupling rod 310 extending through hearing device core 202 (e.g., protrusions 312 may be integral with hearing device core 202 and/or protrusions 312 may be attached, such as by adhesive, to hearing device core 202).

In some examples, hearing device core 202 further includes a screen 314 and/or a pair of tabs 316 that may be used during insertion and/or removal of a hearing device system 200 into the ear. Moreover, hearing device core 202 is not limited to any particular type of hearing device core 202. For example, other exemplary hearing device cores are illustrated and described in, for example, U.S. Pat. No. 8,761,423, filed on Nov. 23, 2011 and entitled “Canal Hearing Devices and Batteries For Use With Same,” which is incorporated herein by reference.

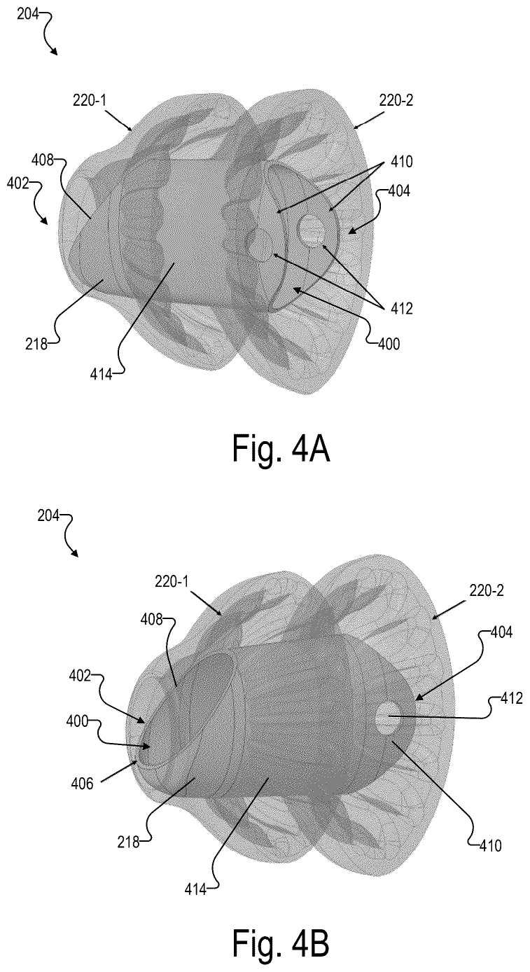

FIGS. 4A and 4B show an illustrative implementation of hearing device seal module 204. For example, FIGS. 4A and 4B each show a perspective view of hearing device seal module 204.

As shown, seal carrier 218 of hearing device seal module 204 includes a sleeve-shaped body (e.g., a hollow body configured to receive hearing device core 202) formed by a sufficiently rigid material (e.g., plastic, etc.) that retains a level of stiffness so as to maintain the shape of seal carrier 218 during handling (e.g., during insertion and/or removal of hearing device core 202 within hearing device seal module 204, during insertion and/or removal of hearing device system 200 within the ear canal, etc.). The sleeve shape of seal carrier 218 defines an internal lumen 400 (i.e., a volume or interior space radially delimited by the seal carrier 218) extending therethrough from a medial end 402 of seal carrier 218 to a lateral end 404 of seal carrier 218. Lumen 400 is sized to correspond to housing 206 of hearing device core 202 such that lumen 400 is configured to receive housing 206 of hearing device core 202 within lumen 400. For example, lumen 400 may have an oval cross-sectional shape associated with hearing device core 202, which may facilitate proper orientation of hearing device core 202 during insertion within seal carrier 218. Seal carrier 218 may have a minimal thickness configured to provide the sufficient rigidity.

Medial end 402 of seal carrier 218 includes an edge 406 extending inward (e.g., towards lumen 400) and that is configured to abut (e.g., contact or nearly contact) medial end 208 of housing 206 of hearing device core 202 to stop hearing device core 202 from being inserted beyond edge 406 during insertion of hearing device core 202 within hearing device seal module 204. Accordingly, edge 406 is configured to accurately and repeatedly position hearing device core 202 relative to hearing device seal module 204 and prevent hearing device core 202 from being inserted farther than designed (e.g., beyond edge 406).

Medial end 402 of seal carrier 218 further includes a sound outlet 408 configured to be aligned with receiver port 212 of hearing device core 202. In the illustrated implementation, sound outlet 408 includes an angled cutout that is configured to allow at least a portion of housing 206 of hearing device core 202 to protrude from sound outlet 408. For example, the angled cutout may allow receiver port 212 to protrude from the angled cutout and/or decrease a thickness of hearing device system 200 at the angled cutout. The region of seal carrier 218 having the decreased thickness may be positioned closest to the tympanic membrane of a user when hearing device system 200 is inserted within the ear canal such as to provide a more comfortable fit of hearing device system 200 for the user and/or prevent medical complications from physical contact with tissue.

Lateral end 404 of seal carrier 218 includes a semi-flexible region 410 configured to temporarily deform during insertion and/or removal of hearing device core 202 relative to hearing device seal module 204. Lateral end 404 of seal carrier 218 further includes at least one cavity 412 configured to interact with hearing device core 202 to releasably couple seal carrier 218 with hearing device core 202. As shown, the at least one cavity 412 is formed by a pair of through-holes each configured to receive a protrusion 312 of hearing device core 202 and semi-permanently secure hearing device seal module 204 with hearing device core 202. Semi-flexible region 410 is formed by a pair of bendable flaps (e.g., living hinges) having a bending degree such that each bendable flap is configured to temporarily deform from an original form when inserting hearing device core 202 into seal carrier 218 and retract automatically to the original form after inserting hearing device core 202 into seal carrier 218 such that at least one cavity 412 engages with at least one protrusion 312. While the illustrated implementation includes the at least one cavity 412 formed by a pair of circular through-holes, still other suitably shaped through-holes (e.g., square, rectangular, oval, etc.) and/or cavities may be used (e.g., a pocket may be formed within the bendable flaps instead of a through-hole). In some examples, the bendable flaps are injection molded with seal carrier 218 such that the bendable flaps are integral with seal carrier 218.

At least one seal element 220 is provided on seal carrier 218, such as on an outer shell surface 414 of seal carrier 218. Seal elements 220 may be glued or otherwise permanently attached to shell surface 414 of seal carrier 218, such as at a manufacturing site. Seal elements 220 may be any suitable seal such as seals commonly employed on extended wear hearing devices and, accordingly, are configured to substantially conform to the shape of walls of the ear canal, maintain an acoustical seal between a seal surface and the ear canal, and retain hearing device core 202 securely within the ear canal. Additional information concerning the specifics of exemplary seals may be found in U.S. Pat. No. 7,580,537, filed on Jun. 13, 2006 and entitled “Sealing Retainer For Extended Wear Hearing Devices,” which is incorporated herein by reference. With respect to materials, seal elements 220 be formed from compliant material configured to conform to the shape of the ear canal. Suitable materials include elastomeric foams having compliance properties (and dimensions) configured to conform to the shape of the intended portion of the ear canal (e.g., the bony portion) and exert a spring force on the ear canal so as to hold the core in place in the ear canal. Exemplary foams, both open cell and closed cell, include but are not limited to foams formed from polyurethanes, silicones, polyethylenes, fluoropolymers and copolymers thereof. Hydrophilic polyurethane foam is one specific example. Accordingly, the at least one seal element 220 may be made of a foamed plastic or a closed-porous material that is flexible and compressible.

In the illustrated implementation, the least one seal element 220 includes a first seal element 220-1 and a second seal element 220-2 provided on seal carrier 218 such that first seal element 220-1 is displaced from second seal element 220-2 by a distance (e.g., in a direction of a longitudinal axis of seal carrier 218). Each of first seal element 220-1 and second seal element 220-2 have an umbrella shape extending outward toward lateral end 404 of seal carrier 218 of equal size. However, seal elements 220 are not limited to any particular type of hearing device seal and may include any suitable number, size, and/or shape of seal element.

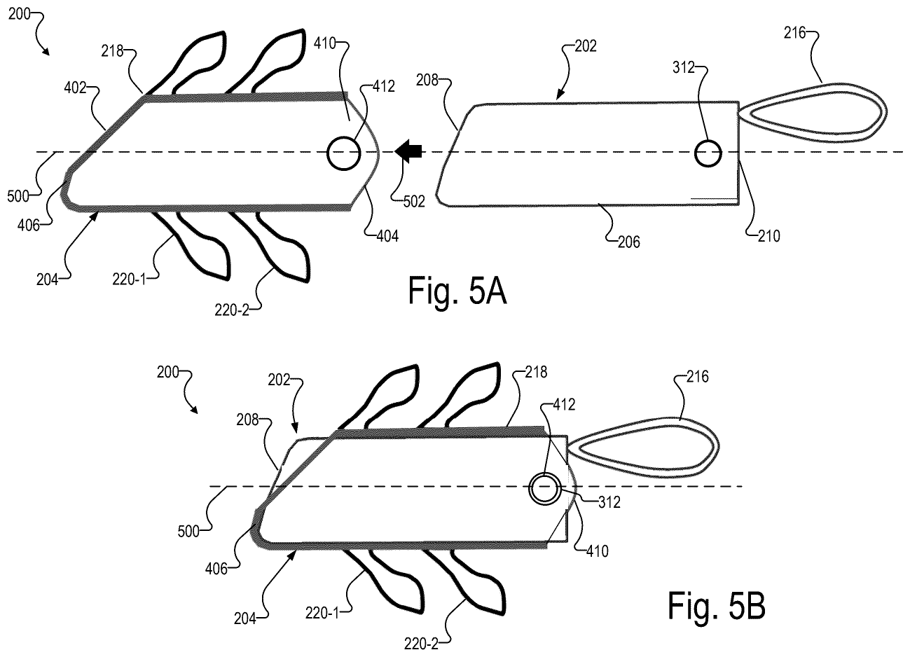

FIGS. 5A and 5B show hearing device core 202 being at least partially inserted within hearing device seal module 204. For example, FIG. 5A shows a side view of hearing device core 202 being inserted into hearing device seal module 204 and FIG. 5B shows a side view of hearing device core 202 coupled with hearing device seal module 204 when hearing device core 202 is at least partially inserted within hearing device seal module 204.

As shown, seal carrier 218 defines a longitudinal axis 500 such that hearing device core 202 is at least partially inserted into seal carrier 218 from lateral end 404 of seal carrier 218 towards medial end 402 of seal carrier 218 in a direction of longitudinal axis 500, as indicated by arrow 502. For example, medial end 208 of hearing device core 202 is inserted within lumen 400 of seal carrier 218 at lateral end 404 of seal carrier 218. Hearing device core 202 is inserted through lumen 400 until medial end 208 of hearing device core 202 abuts edge 406 of seal carrier 218 and/or until protrusion 312 of hearing device core 202 engages with cavity 412 of seal carrier 218.

Seal carrier 218 is secured to hearing device core 202 by a releasable form-fit coupling. For example, the coupling comprises a snap-fit mechanism having at least one protrusion 312 and at least one cavity 412 such that the at least one protrusion 312 is configured to engage the at least one cavity 412 corresponding to the at least one protrusion 312. When hearing device core 202 is inserted within seal carrier 218, the at least one protrusion 312 is configured to insert into the at least one cavity 412 to secure the hearing device core 202 with seal carrier 218. The at least one protrusion 312 may further be released from the at least one cavity 412 to decouple hearing device core 202 from seal carrier 218.

Accordingly, the releasable form-fit coupling is configured to releasably couple hearing device core 202 with seal carrier 218 based on the at least one protrusion 312 interlocking with the at least one cavity 412 to maintain the position of hearing device core 202 within seal carrier 218. In some instances, seal carrier 218 is sized such that there is no interference and/or friction between hearing device core 202 and seal carrier 218 when hearing device core 202 is inserted within seal carrier 218 (e.g., seal carrier 218 has minimal or no contact with housing 206 of hearing device core 202 such that hearing device core 202 slides easily within seal carrier 218 without interference and/or friction). In instances when there is no interference and/or friction between seal carrier 218 and hearing device core 202, the releasable form-fit coupling solely secures hearing device core 202 with seal carrier 218. Alternatively, seal carrier 218 may be sized to provide an interfere fit and/or a friction fit with housing 206 of hearing device core 202 to secure seal carrier 218 with hearing device core 202 in addition to the releasable form-fit coupling.

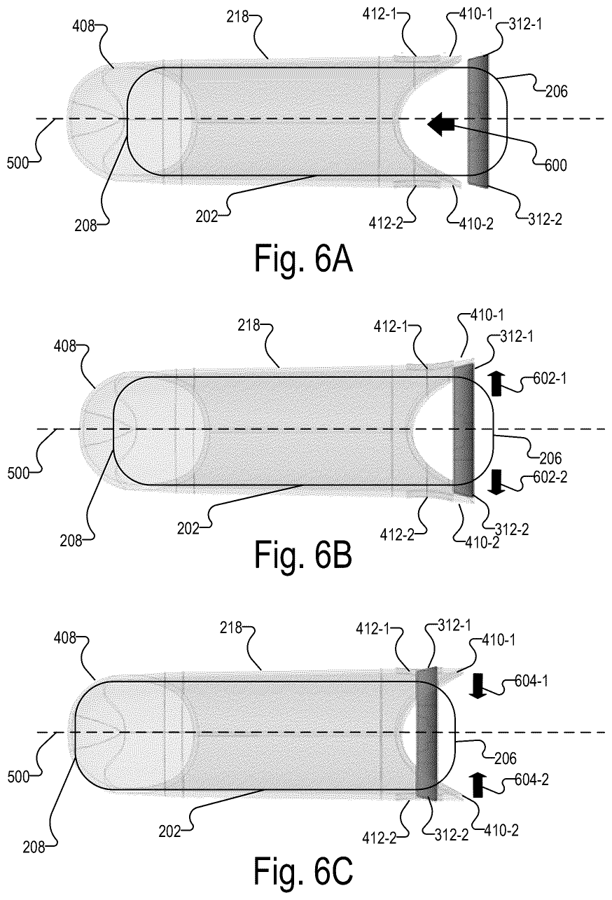

FIGS. 6A-6C further illustrate a top view of hearing device core 202 being at least partially inserted within hearing device seal module 204. Hearing device seal module 204 is shown without sealing elements 220 and hearing device core 202 is shown without removal loop 216 in FIGS. 6A-6C for illustrative purposes.

FIG. 6A shows medial end 208 of hearing device core 202 being inserted within seal carrier 218 of hearing device seal module 204, as indicated by arrow 600. As shown, seal carrier 218 includes a first cavity 412-1 formed by a first through-hole at a first semi-flexible region 410-1 formed by a first bendable flap and a second cavity 412-2 formed by a second through-hole at a second semi-flexible region 410-2 formed by a second bendable flap. First cavity 412-1 and second cavity 412-2 are aligned with each other in a plane extending through longitudinal axis 500. First cavity 412-1 is configured to receive a first protrusion 312-1 of hearing device core 202 and second cavity 412-2 is configured to receive a second protrusion 312-2 of hearing device core 202. For example, first protrusion 312-1 and second protrusion 312-2 may be formed on housing 206 of hearing device core 202 such as to extend outwardly from housing 206. As shown, both first protrusion 312-1 and second protrusion 312-2 are chamfered to taper inwardly toward medial end 208 of hearing device core 202.

As shown in FIG. 6B, as hearing device core 202 is inserted within seal carrier 218, first protrusion 312-1 engages first semi-flexible region 410-1 to bend first semi-flexible region 410-1 outward (e.g., away from longitudinal axis 500), as indicated by first arrow 602-1, and second protrusion 312-2 engages second semi-flexible region 410-2 to bend second semi-flexible region 410-2 outward (e.g., away from longitudinal axis 500), as indicated by second arrow 602-2. As shown in FIG. 6C, when hearing device core 202 is at least partially inserted within seal carrier 218, first protrusion 312-1 engages first cavity 412-1 to insert within first cavity 412-1 and interlock with first cavity 412-1. First semi-flexible region 410-1 further bends back inward (e.g., toward longitudinal axis 500), as indicated by first arrow 604-1, to secure first protrusion 312-1 within first cavity 412-1. Likewise, second protrusion 312-2 engages second cavity 412-2 to insert within second cavity 412-2 and interlock with second cavity 412-2. Second semi-flexible region 410-2 further bends back inward (e.g., toward longitudinal axis 500), as indicated by second arrow 604-2, to secure second protrusion 312-2 within second cavity 412-2. Protrusions 312 and cavities 412 thereby secure hearing device core 202 with seal carrier 218 to hold hearing device core 202 within seal carrier 218.

While the releasable coupling in the illustrated implementation includes a pair of cavities 412 and corresponding protrusions 312 provided on opposing sides of hearing device system 200, the releasable coupling may include any suitable number of cavities 412 and/or protrusions 312 positioned at any orientation about seal carrier 218. In some examples, the releasable coupling may include a plurality of cavities 412 and/or protrusions 312 positioned at irregular distances from one another in a circumferential direction relative to longitudinal axis 500, which may facilitate alignment of seal carrier 218 and hearing device core 202 in a predetermined way. Moreover, a plurality of cavities 412 and/or protrusions 312 may provide redundancy in securing seal carrier 218 with hearing device core 202. To illustrate, additional cavities 412 and/or protrusions 312 may secure seal carrier 218 with hearing device core 202 if a cavity 412 and corresponding protrusion 312 fail to interlock.

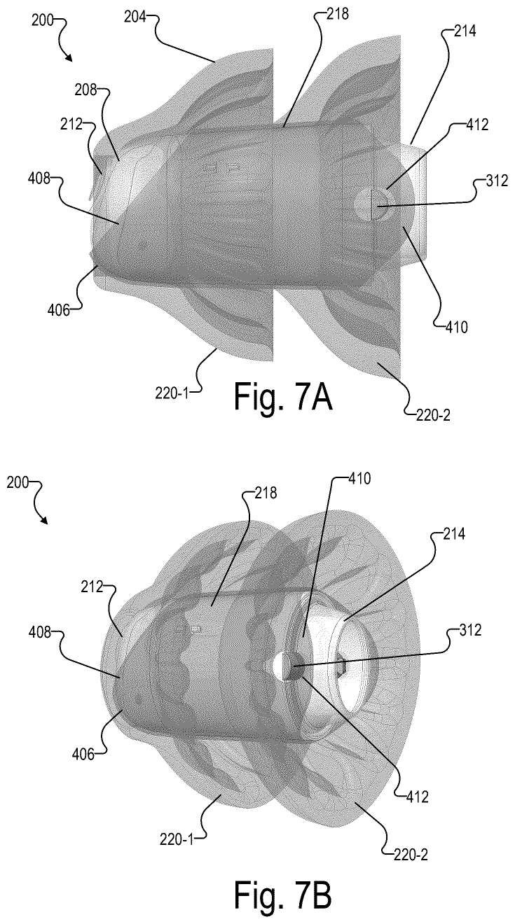

FIGS. 7A and 7B show an illustrative implementation of hearing device system 200 when hearing device core 202 is at least partially inserted within hearing device seal module 204. For example, FIG. 7A shows a side view of hearing device core 202 coupled with seal carrier 218 by a releasable form-fit coupling and FIG. 7B shows a perspective view of hearing device core 202 coupled with seal carrier 218 by a releasable form-fit coupling.

As shown, when hearing device core 202 is coupled with seal carrier 218, seal carrier 218 positions hearing device core 202 within seal carrier 218. For example, hearing device core 202 is positioned such that receiver port 212 of hearing device core 202 is aligned with sound outlet 408 of seal carrier 218. In some instances, sound outlet 408 and/or at least a portion of medial end 208 of hearing device core 202 may protrude through sound outlet 408. Moreover, hearing device core 202 is positioned such that medial end 208 of hearing device core 202 abuts edge 406 of seal carrier 218 and the at least one protrusion 312 of the contamination guard 214 is engaged with the at least one cavity 412 to secure hearing device core 202 with seal carrier 218.

To decouple hearing device core 202 from seal carrier 218, semi-flexible regions 410 may be deformed outward (e.g., away from longitudinal axis 500) to release each protrusion 312 from a respective cavity 412. Hearing device core 202 (e.g., lateral end 210 of hearing device core 202) may be pulled away from seal carrier 218, such as by removal loop 216, to remove hearing device core 202 from seal carrier 218. In some examples, hearing device core 202 may be at least partially inserted within another seal carrier 218 and/or seal carrier 218 may receive another hearing device core 202.

Still other suitable configurations for the releasable form-fit coupling may be used to secure hearing device core 202 with seal carrier 218. For example, while the at least one protrusion 312 is shown on hearing device core 202 and the at least one cavity 412 is shown on seal carrier 218, the least one protrusion 312 may additionally or alternatively be included on seal carrier 218 and/or the at least one cavity 412 may additionally or alternatively be included on hearing device core 202. Additionally or alternatively, semi-flexible regions 410 may be included on hearing device core 202 (e.g., protrusions 312 may be configured to temporarily deform inward and/or outward to engage cavities 412). Moreover, one or more resilient members (e.g., springs, etc.) may be used in addition to or instead of a living hinge provided by resilient material at semi-flexible regions 410.

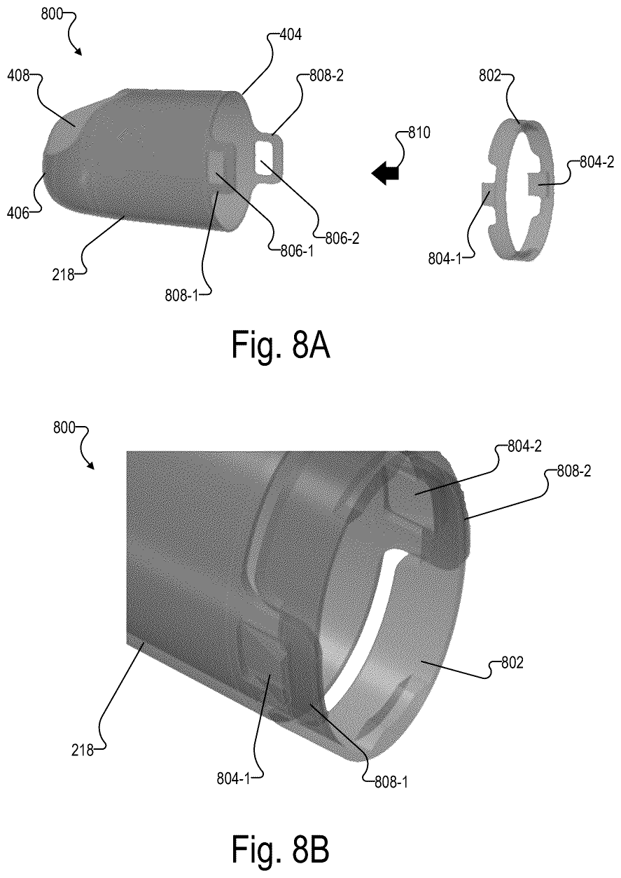

As an illustrative example, FIGS. 8A and 8B show another implementation 800 of a releasable form-fit coupling for use with hearing device system 200 (e.g., to secure hearing device core 202 with seal carrier 218). As shown, the releasable form-fit coupling comprises a ring-shaped locking element 802 including at least one protrusion 804 (e.g., protrusions 804-1 to 804-2) configured to engage with at least one cavity 806 (e.g., cavities 806-1 to 806-2) of seal carrier 218. As an illustrative example, the at least one protrusion 804 includes at least one fin extending outward from ring-shaped locking element 802 on each opposing side of ring-shaped locking element 802. In some examples, ring-shaped locking element 802 is configured to attach to hearing device core 202, such as lateral end 210 of housing 206. In some other examples, ring-shaped locking element 802 is integral with hearing device core 202 (e.g., the at least one protrusion 804 extends outwardly from housing 206). In some examples, ring-shaped locking element 802 is integrated into a contamination guard 214. In some embodiments, the contamination guard 214 is also held by the ring-shaped locking element 802 or removably attached thereto.

Seal carrier 218 includes the at least one cavity 806 positioned within a flap 808 (e.g., flaps 808-1 to 808-2). Cavities 806 may implement or be similar to cavities 412 and/or flaps 808 may implement or be similar to semi-flexible regions 410. For example, a pair of flaps 808 are provided on lateral end 404 of seal carrier 218 that each include a cavity 806 having a through-hole sized and positioned to receive a respective protrusion 804. As shown in FIG. 8A, protrusions 804 of ring-shaped locking element 802 may be aligned with cavities 806 when ring-shaped locking element 802 is moved toward seal carrier 218, as indicated by arrow 810. As shown in FIG. 8B, when ring-shaped locking element 802 is coupled with seal carrier 218, each protrusion 804 of ring-shaped locking element 802 inserts within and engages a respective cavity 806 to semi-permanently secure ring-shaped locking element 802 with seal carrier 218 (e.g., to prevent unintentional separation between seal carrier 218 and hearing device core 202). For example, a first protrusion 804-1 is inserted within a first cavity 806-1 and a second protrusion 804-2 is inserted within a second cavity 806-2.

In some examples, flaps 808 are semi-flexible such that, when ring-shaped locking element 802 is being coupled with seal carrier 218, flaps 808 are configured to temporarily deform outward from an original form and then back inward to the original form to engage protrusions 804. Additionally or alternatively, protrusions 804 may be semi-flexible such that, when ring-shaped locking element 802 is being coupled with seal carrier 218, protrusions 804 are configured to temporarily deform inward from an original form and then back outward to the original form to engage protrusions 804. In instances where protrusions 804 are semi-flexible, flaps 808 may be rigid such that flaps 808 are configured to receive protrusions 804 without temporarily deforming.

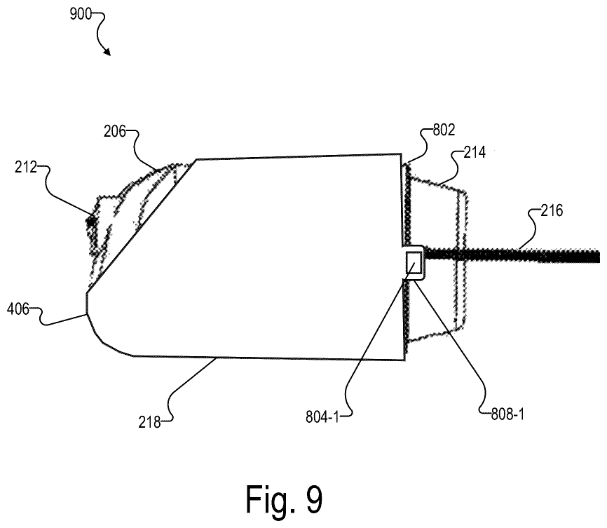

FIG. 9 shows an illustrative implementation 900 in which ring-shaped locking element 802 is coupled with housing 206 of hearing device core 202 (e.g., at lateral end 210) such that, when hearing device core 202 is inserted within seal carrier 218, protrusions 804 of ring-shaped locking element 802 insert within cavities 806. In this embodiment, the contamination guard 214 is integrated to the ring-shaped locking element 802. To decouple hearing device core 202 from seal carrier 218, each flap 808 may deform outward (e.g., away from longitudinal axis 500) and/or each protrusion 804 may deform inward (e.g., toward longitudinal axis 500) to release each protrusion 804 from a respective cavity 806. Hearing device core 202 (e.g., lateral end 210 of hearing device core 202) may be pulled away from seal carrier 218, such as by removal loop 216, to remove hearing device core 202 from seal carrier 218. In some examples, hearing device core 202 may be at least partially inserted within another seal carrier 218 and/or seal carrier 218 may receive another hearing device core 202.

Still other suitable configurations for the releasable form-fit coupling may be used. For example, protrusions 804 may be provided on seal carrier 218, while cavities 806 are provided on ring-shaped locking element 802. Additionally or alternatively, cavities 806 may be provided on a body of seal carrier 218 without flaps 808. Moreover, the releasable form-fit coupling may include any suitable number of protrusions 804 and/or cavities 806 having any suitable shape (e.g., rectangular, fin-shaped, wedge-shaped, circular, etc.) and/or positioned at any suitable orientation about seal carrier 218 and/or hearing device core 202.

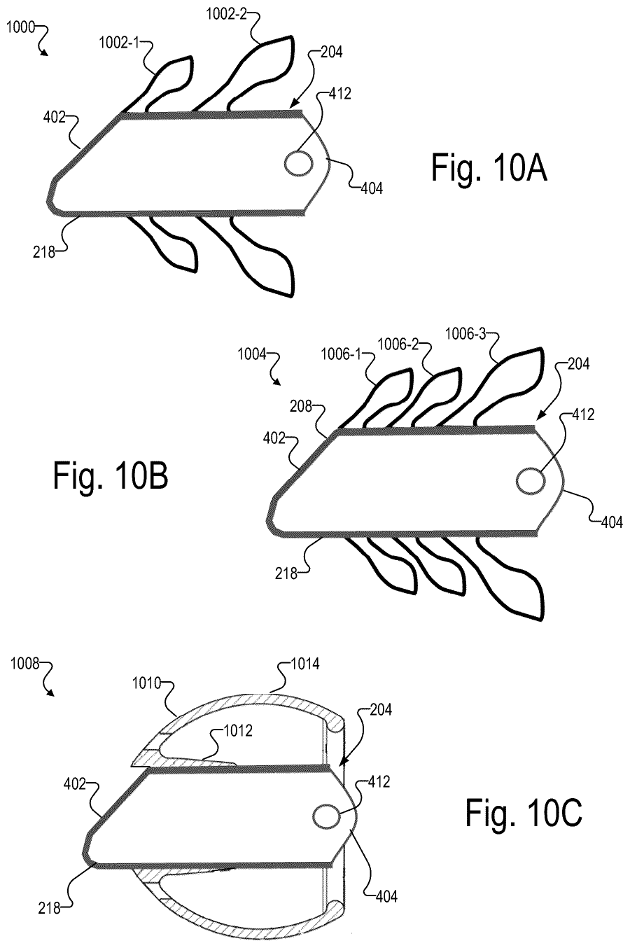

Additionally or alternatively, hearing device seal module 204 may include any suitable configuration of seal elements (e.g., seal elements 220). To illustrate, FIGS. 10A-10C show hearing device seal module 204 having various configurations of seal elements.

As shown, FIG. 10A depicts an illustrative implementation 1000 of hearing device seal module 204 having a first seal element 1002-1 and a second seal element 1002-2 that that may implement or be similar to seal elements 220 such that each seal element 1002 includes an umbrella shape. Moreover, second seal element 1002-2 (e.g., positioned laterally relative to first seal element 1002-1) is sized larger than first seal element 1002-1 such that second seal element 1002-2 has a larger diameter than first seal element 1002-1.

FIG. 10B depicts another illustrative implementation 1004 of hearing device seal module 204 having three seal elements 1006 (e.g., seal elements 1006-1 to 1006-3). For example, a first seal element 1006-1 is positioned toward medial end 208 of seal carrier 218, a second seal element 1006-2 is positioned on seal carrier 218 laterally relative to first seal element 1006-1, and a third seal element 1006-3 is positioned on seal carrier 218 laterally relative to second seal element 1006-2. Each seal element 1006 may implement or be similar to seal elements 220 such that each seal element 1006 includes an umbrella shape. In the illustrative implementation, first seal element 1006-1 and second seal element 1006-2 are equal in size, while third seal element 1006-3 is larger in size such that third seal element 1006-3 has a larger diameter than first seal element 1006-1 and second seal element 1006-2. Alternatively, second seal element 1006-2 may have a larger size than first seal element 1006-1.

FIG. 10C depicts another illustrative implementation 1008 of hearing device seal module 204 having a seal element 1010 positioned on seal carrier 218. Seal element 1010 may implement or be similar to seal elements 220 except that seal element 1010 includes a dome shape instead of an umbrella shape. To illustrate, seal element 1010 includes an inner flange 1012 attached to seal carrier 218 (e.g., at outer shell surface 414) and a dome portion 1014 extending outwardly (e.g., from longitudinal axis 500) from about medial end 402 of seal carrier 218 to about lateral end 404 of seal carrier 218. Seal element 1010 may be glued or otherwise permanently attached to seal carrier 218, such as at a manufacturing site. Seal element 1010 may be configured to substantially conform to the shape of walls of the ear canal, maintain an acoustical seal between a seal surface and the ear canal, and retain hearing device core 202 securely within the ear canal. In some examples, dome-shaped seal element 1010 is provided on seal carrier 218 in addition to umbrella shaped seal elements (e.g., seal elements 220, 1002, and/or 1006).

Accordingly, hearing device seal module 204 may be provided with a various number of seal elements having different shapes and/or sizes, which may allow hearing device seal module 204 and/or hearing device system 200 to be customizable for users and provide a better fit of hearing device seal module 204 and/or hearing device system 200. For example, providing different shapes and/or sizes of seal elements may accommodate users having non-conical and/or mismatched shaped ear canals. In some instances, a plurality of hearing device seal modules 204 are provided at a fitting facility, each hearing device seal module 204 having a different number, size, and/or shape of seal elements. During a fitting process, a hearing device seal module 204 may be selected from the plurality of hearing device seal modules 204 that includes one or more seal elements that best fits an ear canal of the user such that the selected hearing device seal module 204 may be coupled with a hearing device core 202 and inserted within the ear canal of the user.

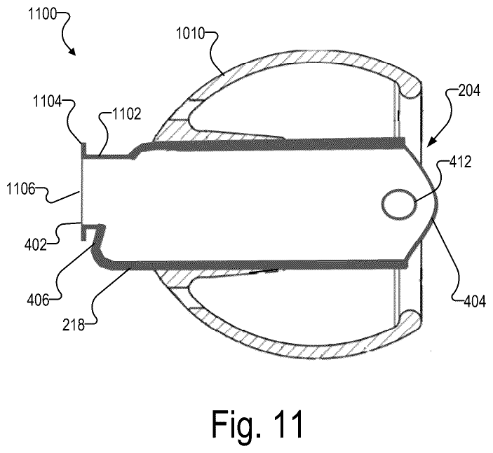

In some implementations, hearing device seal module 204 may include an additional coupling configured to be coupled with an auxiliary element (e.g., a cerumen filter or wax filter etc.). To illustrate, FIG. 11 shows an implementation 1100 of a hearing device seal module 204 that includes an additional coupling at medial end 402 of seal carrier 218. As shown, the additional coupling includes a channel 1102 extending beyond edge 406 at medial end 402 of seal carrier 218 and an annular rim 1104 extending outwardly (e.g., away from longitudinal axis 500) about channel 1102. An opening of channel 1102 at medial end 402 provides a sound outlet 1106 that may implement or be similar to sound outlet 408.

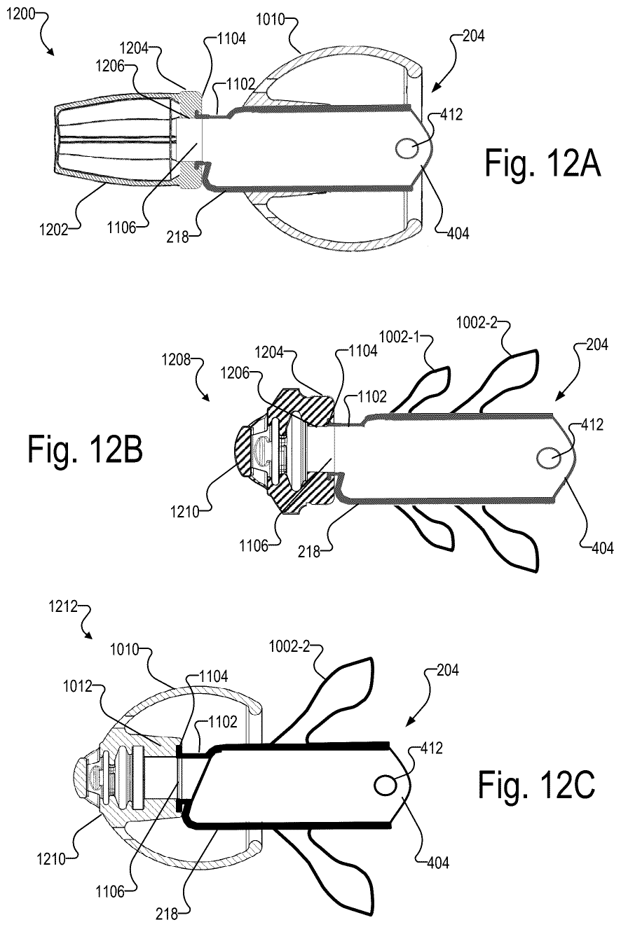

FIGS. 12A-12C show hearing device seal module 204 coupled to various auxiliary elements via the additional coupling. For example, FIG. 12A shows an illustrative implementation 1200 of hearing device seal module 204 coupled with a mechanical element 1202. Mechanical element 1202 includes a structure having thinner portions and thicker portions such that the structure is configured modify sound (e.g., output by hearing device core 202) in a desired way (e.g., the thinner and thicker portions can be geometrically designed to modify a frequency response and/or a pressure of the outputted sound) and/or protect against an ingress of substances. Examples of such mechanical elements 1202 are illustrated and described in, for example, U.S. patent application Ser. No. 18/932,386, filed on Oct. 30, 2024 and entitled “Hearing Device Comprising a Mechanical Element for Sound Transmission,” which is incorporated herein by reference.

In the illustrated implementation, mechanical element 1202 includes a coupling 1204 having an opening 1206 formed therethrough. In some examples, coupling 1204 is injection molded with mechanical element 1202 or otherwise attached to mechanical element 1202. Coupling 1204 is configured to couple with the additional coupling of hearing device seal module 204 such that sound outlet 1106 aligns with opening 1206. For example, coupling 1204 may be configured to receive channel 1102 of hearing device seal module 204 to couple mechanical element 1202 with hearing device seal module 204. In some examples, rim 1104 is configured to maintain a position of coupling 1204 relative to channel 1102 such as to prevent unintended separation of mechanical element 1202 from hearing device seal module 204 (e.g., coupling 1204 may include a recess about opening 1206 configured to receive rim 1104). Coupling 1204 may be releasably coupled with channel 1102, such as by a form-fit, friction fit, snap-fit, threading, etc. Still other suitable auxiliary elements may be coupled with hearing device seal module 204.

For example, FIG. 12B shows an illustrative implementation 1208 of hearing device seal module 204 coupled with a cap 1210 via the additional coupling. Cap 1210 is configured to span sound outlet 1106 and form a filtering element in that it inhibits earwax and other pollutants from directly entering the sound outlet 1106. Examples of such mechanical caps 1210 are illustrated and described in, for example, U.S. patent application Ser. No. 18/815,292, filed on Aug. 26, 2024 and entitled “Ear Tip with Filtering Element for a Hearing Device or for a Hearing Device Part,” which is incorporated herein by reference. Cap 1210 is attached with coupling 1204 configured to couple with the additional coupling of hearing device seal module 204 for coupling cap 1210 with hearing device seal module 204.

Additionally or alternatively, the auxiliary element may include another seal element (e.g., seal elements 220, 1002, 1006, 1010). For example, FIG. 12C shows an illustrative implementation 1212 in which cap 1210 includes a dome-shaped seal element 1010 such that the additional coupling of hearing device seal module 204 is used to couple seal element 1010 with hearing device seal module 204 (e.g., in addition to one or more other seal elements 1002-2 provided on seal carrier 218). In some examples, seal element 1010 is integral with cap 1210 (e.g., seal element 1010 may be injection molded with cap 1210). Still other suitable couplings may be used to couple hearing device seal module 204 with one or more auxiliary elements.

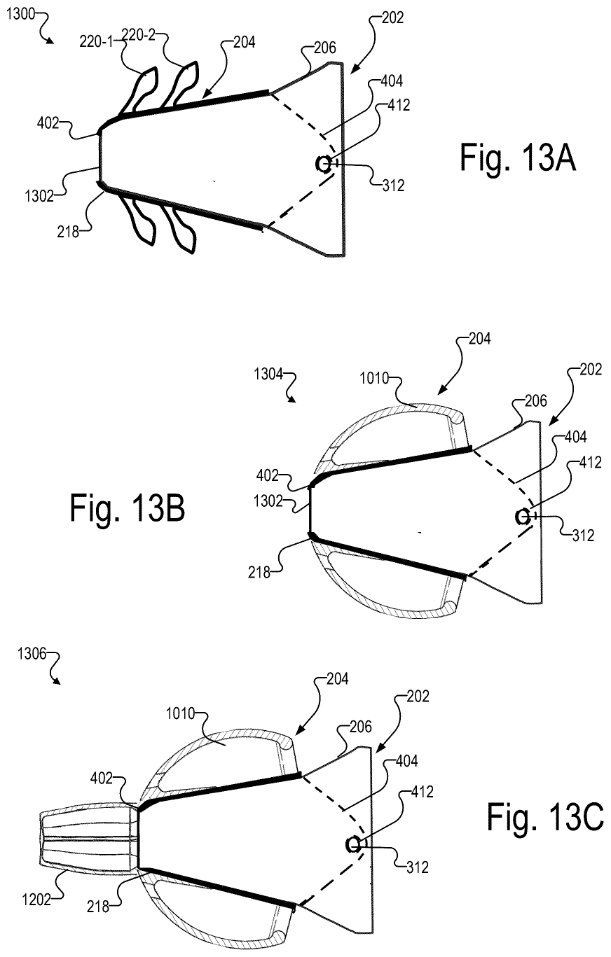

In some implementations, hearing device seal module 204 may include a seal carrier 218 having a tapered sleeve-shape such that an inner diameter of seal carrier 218 at lateral end 404 of seal carrier 218 is wider than an inner diameter of seal carrier 218 at medial end 402. For example, FIGS. 13A-13C show hearing device seal module 204 having a tapered sleeve-shape, such as, for example, an ITE-type hearing device. To illustrate, FIG. 13A shows an illustrative implementation 1300 of hearing device seal module 204 having a seal carrier 218 in which an inner diameter of seal carrier 218 at lateral end 404 of seal carrier 218 is wider than an inner diameter of seal carrier 218 at medial end 402. As shown, housing 206 of hearing device core 202 further tapered such that an outer diameter of housing 206 increases in a lateral direction to correspond to the inner diameter of seal carrier 218. In instances where seal carrier 218 and housing 206 are tapered, the tapered shape may provide a stop to prevent hearing device core 202 from being over-inserted within seal carrier 218 (e.g., such that edge 406 may optionally be omitted).

In the illustrated implementation, seal carrier 218 further includes a sound permeable membrane 1302 covering the entire sound outlet (e.g., sound outlet 408) of seal carrier 218. Sound permeable membrane 1302 may be provided as a wax filter configured to prevent substances from entering hearing device core 202 and/or hearing device seal module 204. For example, sound permeable membrane 1302 may comprise a fine and dense mesh that blocks cerumen, for instance at medial end 402 of seal carrier 218 (e.g., in front of receiver 306). Sound permeable membrane 1302 is acoustically open so as to allow a transmission of sound through sound permeable membrane 1302 with a rather small impact and/or acceptable changes of the sound output.

While the illustrated implementation shows hearing device seal module 204 having a pair of umbrella shaped seal elements 220, hearing device seal module 204 may additionally or alternatively include other types of seal elements and/or auxiliary elements. For example, FIG. 13B shows an illustrative implementation 1304 of hearing device seal module 204 having a tapered sleeve-shape that includes a dome-shaped seal element 1010. FIG. 13C further shows an illustrative implementation 1306 of hearing device seal module 204 having a tapered sleeve-shape that includes a mechanical element 1202 having a dome-shaped seal element 1010.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. An in-the-ear hearing device seal module for use with a hearing device core, comprising:
a sleeve-shaped seal carrier that defines a longitudinal axis and that is configured to be inserted into an ear canal, wherein the seal carrier includes a sound outlet at a medial end of the seal carrier when the seal carrier is inserted into the ear canal; and
at least one seal element provided on a shell surface of the seal carrier;
wherein the hearing device core is at least partially inserted into and positioned by the seal carrier; and
wherein the seal carrier is secured to the hearing device core by a releasable form-fit coupling.

2. The hearing device seal module according to claim 1, wherein the device core is at least partially inserted into the seal carrier from a lateral end of the seal carrier towards the medial end of the seal carrier in a direction of the longitudinal axis.

3. The hearing device seal module according to claim 1, wherein the coupling comprises a snap-fit mechanism having at least one protrusion and at least one cavity, the at least one protrusion configured to engage the at least one cavity corresponding to the at least one protrusion.

4. The hearing device seal module according to claim 3, wherein the at least one cavity is provided at a lateral end of the seal carrier.

5. The hearing device seal module according to claim 4, wherein the at least one cavity is formed by two through-holes aligned with each other in a plane extending through the longitudinal axis.

6. The hearing device seal module according to claim 4, wherein the lateral end of the seal carrier includes a bendable flap at least in a region of the coupling, wherein a bending degree of the bendable flap is such that the bendable flap is configured to temporarily deform from an original form when inserting the device core into the seal carrier and retract to the original form after inserting the device core into the seal carrier automatically such that the at least one cavity engages with the at least one protrusion.

7. The hearing device seal module according to claim 3, wherein the at least one protrusion is formed on a housing of the device core.

8. The hearing device seal module according to claim 3, wherein the device core is positioned within the seal carrier by a ring-shaped locking element that comprises the at least one protrusion to engage with the at least one cavity of the seal shell.

9. The hearing device seal module according to claim 8, wherein the at least one protrusion of the ring-shaped locking element includes at least one fin extending outward from the ring-shaped locking element and configured to be inserted within the at least one cavity.

10. The hearing device seal module according to claim 1, wherein an inner diameter of the seal carrier is wider at a lateral end o the seal carrier than an inner diameter of the seal carrier at the medial end.

11. The hearing device seal module according to claim 1, wherein the at least one seal element is made of a foamed plastic or a closed-porous material that is flexible and compressible.

12. The hearing device seal module according to claim 1, wherein the at least one seal element is permanently attached to the seal carrier.

13. The hearing device seal module according to claim 1, wherein the at least one seal element includes a first seal element and a second seal element provided on the seal carrier such that the first seal element is displaced from the second seal element by a distance in a direction of the longitudinal axis.

14. The hearing device seal module according to claim 13, wherein the first seal elements is a different size than the second seal element.

15. The hearing device seal module according to claim 13, wherein the first seal element is a different shape than the second seal element.

16. The hearing device seal module according to claim 1, wherein the seal carrier comprises an additional coupling at the medial end of the seal carrier, the additional coupling configured to couple an auxiliary element with the seal carrier.

17. The hearing device seal module according to claim 16, wherein the additional coupling is a form fit coupling to an auxiliary element.

18. The hearing device seal module according to claim 1, wherein the sound outlet is covered with a sound permeable membrane.

19. The hearing device seal module according to claim 1, wherein the hearing seal module is configured as one of a completely-in-the-canal device or an at least partially in-the-ear device (ITE).

20. A hearing device system comprising:
a hearing device core including a battery, a microphone, a receiver, and control circuitry that are operably connected to one another;
an in-the-ear hearing device hearing seal module comprising:
a sleeve-shaped seal carrier that defines a longitudinal axis and that is configured to be inserted into an ear canal, wherein the seal carrier includes a sound outlet at a medial end of the seal carrier when the seal carrier is inserted into the ear canal; and
at least one seal element provided on a shell surface of the seal carrier;
wherein the hearing device core is at least partially inserted into and positioned by the seal carrier; and
wherein the seal carrier is secured to the hearing device core by a releasable form-fit coupling.
